(19) United States
(12) Patent Application Publication
(10) Pub. No.: US 2025/0254744 A1
(43) Pub. Date: Aug. 7, 2025

(54) TECHNIQUES FOR DSR REPORTING FOR SPLIT BEARER OPERATION

(71) Applicant: Lenovo (Singapore) Pte. Ltd., Singapore (SG)

(72) Inventors: Joachim Löhr, Wiesbaden (DE); Shwetha Sreejith, Hessen (DE)

(21) Appl. No.: 19/041,896

(22) Filed: Jan. 30, 2025

Related U.S. Application Data
(60) Provisional application No. 63/549,425, filed on Feb. 2, 2024.

(51) Int. Cl. H04W 76/15; H04W 76/22; H04W 80/02

(52) U.S. Cl. CPC H04W 76/15; H04W 76/22; H04W 80/02

(57) ABSTRACT

Various aspects of the present disclosure relate to techniques for delay status reported (DSR) for split bearer operation. An apparatus is configured to associate a packet data convergence protocol (PDCP) entity with a primary radio link control (RLC) entity and at least one secondary RLC entity, indicate a data volume associated with the PDCP entity to a medium access control (MAC) entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

### TECHNICAL FIELD

The present disclosure relates to wireless communications, and more specifically to techniques for delay status reported (DSR) for split bearer operation.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to associate a packet data convergence protocol (PDCP) entity with a primary radio link control (RLC) entity and at least one secondary RLC entity, indicate a data volume associated with the PDCP entity to a medium access control (MAC) entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

A method for wireless communication performed by a UE is described. The method may be configured to, capable of, or operable to associate a PDCP entity with a primary RLC entity and at least one secondary RLC entity, indicate a data volume associated with the PDCP entity to a MAC entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

A processor for wireless communication is described. The processor may be configured to, capable of, or operable to associate a PDCP entity with a primary RLC entity and at least one secondary RLC entity, indicate a data volume associated with the PDCP entity to a MAC entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

A network equipment (NE) for wireless communication is described. The NE may be configured to, capable of, or operable to determine a threshold associated with an amount of data available for transmission for DSR for a split bearer, transmit the determined threshold to a UE for DSR, and receive communications from the UE in accordance with the determined threshold.

A processor for wireless communication is described. The processor may be configured to, capable of, or operable to determine a threshold associated with an amount of data available for transmission for DSR for a split bearer, transmit the determined threshold to a UE for DSR, and receive communications from the UE in accordance with the determined threshold.

A method for wireless communication performed by an NE is described. The method may be configured to, capable of, or operable to determine a threshold associated with an amount of data available for transmission for DSR for a split bearer, transmit the determined threshold to a UE for DSR, and receive communications from the UE in accordance with the determined threshold.

### BRIEF DESCRIPTION OF THE DRAWINGS

FIG. 1 illustrates an example of a wireless communications system in accordance with aspects of the present disclosure.

FIG. 2A illustrates an example of an information element (IE) for PDCP configuration, in accordance with aspects of the present disclosure.

FIG. 2B is a continuation of the PDCP Configuration IE of FIG. 2A, in accordance with aspects of the present disclosure.

FIG. 2C is a continuation of the PDCP Configuration IE of FIGS. 2A and 2B, in accordance with aspects of the present disclosure.

FIG. 2D is a continuation of the PDCP Configuration IE of FIGS. 2A, 2B, and 2C, in accordance with aspects of the present disclosure.

FIG. 3 illustrates an example of a UE, in accordance with aspects of the present disclosure.

FIG. 4 illustrates an example of a processor, in accordance with aspects of the present disclosure.

FIG. 5 illustrates an example of a network equipment (NE), in accordance with aspects of the present disclosure.

FIG. 6 illustrates a flowchart of a method performed by a UE, in accordance with aspects of the present disclosure.

FIG. 7 illustrates a flowchart of a method performed by an NE in accordance with aspects of the present disclosure.

### DETAILED DESCRIPTION

Generally, the present disclosure describes systems, methods, and apparatuses for DSR reporting for split bearer operation. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

A possible mapping option for extended reality (XR)-communication is where packet data unit (PDU) sets of different importance levels are mapped to the same quality of service (QoS) flow and radio bearer. One example of such a mapping option would be where, for example, I-frames and P-frames of a video stream are carried by the same QoS flow/radio bearer.

A QoS flow/radio bearer for XR traffic may carry PDU sets with a different importance level (PDU session ID level), e.g., I-frames and P-frames of a video stream. According to the legacy QoS architecture, data packets of a radio bearer experience the same QoS treatment. To allow for distinguished handling of PDU sets associated with a high importance level in certain scenarios, e.g., prioritization of high importance data and discarding of low importance data (in case of congestion), new layer 2 procedures/mechanisms are needed.

This disclosure provides solutions to the foregoing using a data volume calculation for the purpose of DSR, e.g., for the case where an XR service is mapped to a split bearer. A split bearer for dual connectivity includes a bearer whose radio protocols are located in both the master gNB (MgNB) and the secondary gNB (SgNB) to use both MgNB and SgNB resources. Further, it should be noted that a split secondary RLC entity for dual connectivity is an RLC entity different from the primary RLC entity that is responsible for split bearer operation. If the PDCP entity is associated with two RLC entities, the split secondary RLC entity is the RLC entity other than the primary RLC entity. If the PDCP entity is associated with more than two RLC entities, the split secondary RLC entity is configured by upper layers.

As used herein, PDCP entities are located in the PDCP sublayer. Several PDCP entities may be defined for a UE. In one embodiment, each PDCP entity carries the data of one radio bearer. A PDCP entity, in one embodiment, is associated either with the control plane or the user plane depending on which radio bearer it is carrying data for. In one embodiment, each data radio bearer is associated with one PDCP entity. In one embodiment, each PDCP entity is associated with one, two, or more RLC entities depending on the RB characteristic (e.g., uni-directional/bi-directional or split/non-split) or RLC mode. For split bearers, each PDCP entity is associated with two unacknowledge mode (UM) RLC entities (for same direction), four UM RLC entities (two for each direction), or two acknowledge mode (AM) RLC entities. In one embodiment, there is a transmitting PDCP entity and a receiving PDCP entity for a radio bearer.

As used herein, an RLC entity receives/delivers RLC SDUs from/to upper layer and sends/receives RLC PDUs to/from its peer RLC entity via lower layers. In one embodiment, there is a transmitting side and receiving side of an RLC entity. Functions of the RLC sub layer may be performed by RLC entities. For an RLC entity configured at the gNB, there is a peer RLC entity configured at the UE and vice-versa.

In one embodiment, for UL split bearer operation (e.g., PDCP entity is associated with more than one RLC entity), the PDCP entity compares a data volume against a configured threshold to determine whether a PDCP PDU can be submitted to the primary RLC entity and/or to the other RLC entities other than the primary RLC entity. As used herein, a data volume may include an amount of data available for transmission in a PDCP entity which is delay-critical (data which is close to its delay budget respectively for which the discard timer is close to expiry).

In one embodiment, if the total amount of PDCP data volume and RLC data volume pending for initial transmission in the primary RLC entity and the split secondary RLC entity is equal to or larger than the configured threshold (e.g., a threshold value for uplink data split operation, UL-dataSplitThreshold), the PDCP entity can submit a PDCP PDU to the primary RLC entity or the (split) secondary RLC entity. Also, for the purpose of MAC buffer status reporting, in one embodiment, the PDCP entity compares the same data volume against the threshold (e.g., UL-dataSplitThreshold) to determine whether the PDCP data volume is indicated to the MAC entity associated with the primary RLC entity and/or also to the MAC entity associated with the (split) secondary RLC entity. For the DSR reporting, in one embodiment, the data volume calculation is also defined for the split bearer case.

In particular, since the amount of delay-critical PDCP service data units (SDUs)/PDUs, which is reported in a DSR MAC control element (CE), is most likely smaller than the data volume that is compared against the threshold (e.g., UL-dataSplitThreshold) for the PDCP transmit operation/buffer status report (BSR), since the data volume is comprised of the total amount of PDCP data volume as well as the RLC data volume pending for initial transmission, it needs to be clarified which data volume is used for determining whether a delay-critical PDCP data volume is reported to the primary MAC entity and/or also to the secondary MAC entity. Otherwise, there could be some mismatch between DSR reporting and the PDCP transmission behavior for the split bearer case. Similar to the BSR reporting, and also for DSR reporting, the UE behavior should be aligned with the PDCP transmission behavior, e.g., when DSR is reporting the delay-critical PDCP PDU data volume to primary as well as secondary RLC entities/paths, then the PDCP layer should be allowed to submit a delay-critical PDCP PDU to either the primary RLC entity or the secondary RLC entity. Situations should be avoided where DSR reports the delay-critical PDCP data volume only to the primary MAC entity/RLC entity, even though the UE/PDCP layer uses multiple paths/links for UL data transmission, e.g., delay-critical PDCP PDUs.

Aspects of the present disclosure are described in the context of a wireless communications system. Note that one or more aspects from different solutions may be combined.

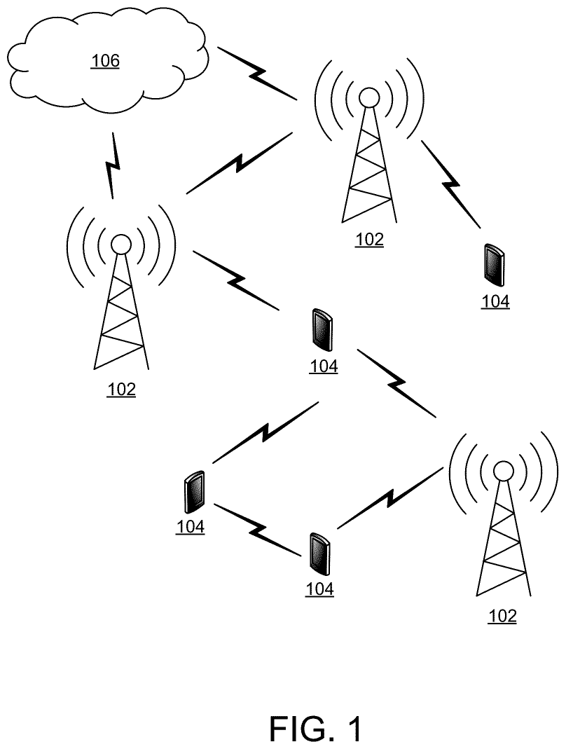

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., =0) may be associated with a first subcarrier spacing (e.g., 15 kHz) and a normal cyclic prefix. In some implementations, the first numerology (e.g., =0) associated with the first subcarrier spacing (e.g., 15 kHz) may utilize one slot per subframe. A second numerology (e.g., =1) may be associated with a second subcarrier spacing (e.g., 30 kHz) and a normal cyclic prefix. A third numerology (e.g., =2) may be associated with a third subcarrier spacing (e.g., 60 kHz) and a normal cyclic prefix or an extended cyclic prefix. A fourth numerology (e.g., =3) may be associated with a fourth subcarrier spacing (e.g., 120 kHz) and a normal cyclic prefix. A fifth numerology (e.g., =4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., =0, =1, =2, =3, =4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., =0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., =0), which includes 15 kHz subcarrier spacing; a second numerology (e.g., =1), which includes 30 kHz subcarrier spacing; and a third numerology (e.g., =2), which includes 60 kHz subcarrier spacing. FR2 may be associated with one or multiple numerologies (e.g., at least 2 numerologies). For example, FR2 may be associated with a third numerology (e.g., =2), which includes 60 kHz subcarrier spacing; and a fourth numerology (e.g., =3), which includes 120 kHz subcarrier spacing.

In one embodiment, regarding DSR reporting, the gNB can use knowledge of the PDU set delay in scheduling transmissions, e.g., by giving priority to transmissions close to their delay budget limit, and by not scheduling (e.g., UL) transmissions exceeding a PDU set delay budget. The UE can also take advantage of such knowledge to conserve the UE's power by determining if a UL transmission (e.g., UL pose or physical uplink shared channel (PUSCH)) corresponding to a transmission that exceeds its delay budget can be dropped. Additionally, the UE does not need to wait for re-transmission of a physical downlink shared channel (PDSCH) that will never occur (e.g., discontinuous reception (DRX) retransmission timers can be stopped). For DL transmissions it is assumed that the gNB is aware of the remaining delay budget of the data pending for transmission, e.g., based on information provided by the session management function (SMF), and takes such knowledge into account in scheduling decisions.

For UL resource allocation, it may be necessary that the UE provide assistance information regarding the remaining delay budget of the data pending in its buffer to the gNB. In one embodiment, the UE provides information on the remaining delay budget of the data for which UL resources are requested. Such assistance information is referred to as DSR reporting. The PDU set delay budget (PSDB) information provided to the RAN is not sufficient. Since the network (NW) is not aware of the exact arrival time of UL data in the buffer and hence is also not sure about the remaining (valid) time of data being pending in the buffer for transmission, the UE provides this information, e.g., remaining delay information, within the DSR reporting. In one embodiment, a new (DSR) MAC CE is introduced for XR-specific logical channel groups (LCGs), which includes the amount of data available for transmission and some remaining delay information associated with the data reported.

Furthermore, in one embodiment, threshold-based DSR reporting is supported, e.g., DSR reporting is triggered when the remaining delay of a PDU/PDU set is below a NW configured threshold. The threshold may be configured per LCG.

As described in clause 5.4.9 of TS 38.321 (incorporated herein by reference), the DSR reporting procedure is used to provide the serving gNB with the delay status of LCGs. This delay status for an LCG includes the remaining time, which is the smallest remaining value of the PDCP discardTimers among SDUs buffered for the LCG, e.g., as specified in clause 7.3 in TS 38.323 (incorporated herein by reference), and the total amount of delay-critical UL data for the LCG according to the data volume calculation procedure, e.g., as specified in clause 5.5 in TS 38.322 (incorporated herein by reference) and clause 5.6 in TS 38.323 (incorporated herein by reference) for the associated RLC and PDCP entities, respectively.

Radio resource control (RRC) controls the DSR procedure by configuring the remainingTimeThreshold parameter, which is the threshold on remaining time for triggering a DSR for an LCG. If an LCG is configured for delay status reporting, the MAC entity shall trigger a DSR for the LCG if the smallest remaining value of the PDCP discardTimers among all the data buffered for the LCG that has not been transmitted in any MAC PDU or reported as data volume in a DSR MAC CE becomes below remainingTimeThreshold of the LCG and if there is no DSR pending for the LCG since the last transmission of a DSR MAC CE.

If there is at least one DSR pending, the MAC entity shall instruct the Multiplexing and Assembly procedure to generate the DSR MAC CE if UL-SCH resources are available for a new transmission and the UL-SCH resources can accommodate the DSR MAC CE plus its subheader as a result of logical channel prioritization. Otherwise, the MAC entity shall trigger a scheduling request (SR) if there is no pending SR already triggered by the DSR procedure for the same logical channel as of this DSR. In one embodiment, the availability of UL-SCH resources for the transmission of the DSR MAC CE may follow the same criteria specified in clause 5.4.5 (incorporated herein by reference).

In one embodiment, an SDU is considered to be associated with a DSR if it is associated with the LCG that triggered the DSR and the remaining value of its PDCP discardTimer is below remainingTime Threshold. In one embodiment, a MAC PDU shall contain at most one DSR MAC CE. In one embodiment, the MAC entity shall not include a DSR MAC CE in a MAC PDU if the MAC PDU can accommodate the SDUs associated with all the pending DSRs.

After a DSR is triggered, in one embodiment, it is considered pending until it is cancelled. In one embodiment, the MAC entity shall cancel a pending DSR, either when all the SDUs associated with the DSR have been discarded, or when a MAC PDU is transmitted, and this MAC PDU includes either all the SDUs associated with the DSR or a DSR MAC CE that contains the delay information of all the SDUs associated with the DSR (as described in the clause 6.1.3.72 (incorporated herein by reference)).

As described in clause 6.1.3.72 of TS 38.321 (incorporated herein by reference), the DSR MAC CE is identified by MAC subheader with an extended logical channel ID (eLCID), e.g., as specified in Table 6.2.1-2b. In one embodiment, the fields in the DSR MAC CE include:

LCGᵢ: This field indicates the presence of delay information (e.g., the Remaining Time and Buffer Size fields) for the LCG i. An LCGᵢ field set to 1 indicates that the delay information for the LCG i is reported. An LCGᵢ field set to 0 indicates that the delay information for the LCG i is not reported.

Remaining Time: This field indicates the shortest remaining value of PDCP discardTimer (e.g., in clause 7.3 in TS 38.323 (incorporated herein by reference)) among all PDCP SDUs buffered for an LCG, at the time of the first symbol of the first PUSCH transmission that includes this DSR MAC CE. The length of this field may be 6 bits. The value r in this field indicates a remaining time within the range of (r, r+1] msec.

BT: This field is present if the corresponding LCG is configured with additionalBSR-TableAllowed; otherwise, this field is reserved. If present, a BT field set to 1 indicates that the buffer sizes specified in Table 6.1.3.1-3 are used to set the value of the Buffer Size field, while a BT field set to 0 indicates that the buffer sizes specified in Table 6.1.3.1-2 are used instead.

Buffer Size: The Buffer Size field indicates the total amount of delay-critical UL data for an LCG according to the data volume calculation procedure specified in clause 5.5 in TS 38.322 (incorporated herein by reference) and clause 5.6 in TS 38.323 (incorporated herein by reference) for the associated RLC and PDCP entities, respectively, after the MAC PDU has been built. If the corresponding LCG is configured with additionalBSR-TableAllowed and the amount of delay-critical UL data for an LCG is within the buffer sizes specified in Table 6.1.3.1-3, the MAC entity shall use the buffer sizes specified in Table 6.1.3.1-3 to set the value of this field; otherwise, the MAC entity shall use Table 6.1.3.1-2 instead. This field is indicated in number of bytes. The length of this field is 8 bits.

The Remaining Time, the BT, and the Buffer Size fields for an LCG shall be reported in two consecutive octets. These three fields for different LCGs shall be included in a DSR MAC CE in ascending order based on the LCGᵢ.

Regarding PSI-based discarding, in one embodiment, PSI can be considered for PDU set discarding in the presence of UL congestion. Therefore, in addition to the timer-based discard mechanism within a given PDCP entity, a PDCP discarding mechanism based on PDU set importance level (PSI) is introduced for XR communications.

In one embodiment, the NW controls the PSI-based discarding at the UE at the presence of congestion. Specifically, the NW explicitly orders the UE to enable/disable PSI-based PDCP discarding, e.g., the NW enables/disables PSI-based discarding, based on a detected congestion. Essentially, the NW is responsible for the detection of congestion and the UE follows the NW signaling.

In one embodiment, the mechanism for PSI-based discarding at the transmitter (Tx) side is a mechanism where the UE is configured with two PDCP discard timer configurations, e.g., discardTimer and discardTimerForLowImportance. If the NW enables PSI-based discarding, in the event of a detected congestion, the UE/PDCP applies the second PDCP discard timer (discardTimerForLowImportance) for low importance PDU sets, e.g., a new timer is started upon reception of an SDU belonging to a low importance PDU Set. Furthermore, in one embodiment, it is left to UE implementation to determine low importance PDU sets.

As background, according to TR 26.928 (incorporated herein by reference), XR is an umbrella term for different types of realities. Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

Augmented reality (AR) is when a user is provided with additional information or artificially generated items or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

XR refers to real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

In one embodiment, many of the XR and CG use cases are characterised by quasi-periodic traffic (with possible jitter) with high data rate in DL (e.g., video steam) combined with the frequent UL (e.g., pose/control update) and/or UL video stream. Both DL and UL traffic are also characterized by relatively strict packet delay budget (PDB).

The set of anticipated XR and CG services has a certain variety and characteristics of the data streams (e.g., video) may change “on-the-fly,” while the services are running over NR. Therefore, additional information on the running services from higher layers, e.g., the QoS flow association, frame-level QoS, PDU set-based QoS, XR specific QoS, etc., may be beneficial to facilitate informed choices of radio parameters. It is clear that XR application awareness by the UE and the gNB would improve the user experience, improve the NR system capacity in supporting XR services, and reduce the UE power consumption.

An Application Data Unit (ADU) or PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. A PDU set can be one or more I-slices, P-slices, I-frame, P-frame, or a combination of those.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

The latency requirement of XR traffic in RAN side (i.e., air interface) is modelled as packet delay budget (PDB). The PDB is a limited time budget for a packet to be transmitted over the air from a gNB to a UE. For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered. The value of PDB may vary for different applications and traffic types, which can be 10-20 ms depending on the application (see TR 26.926 (incorporated herein by reference)).

In one embodiment, 5G arrival time of data bursts on the downlink can be quasi periodic i.e. periodic with jitter. Some of the factors leading to jitter in burst arrival include varying server render time, encoder time, RTP packetization time, link between server and 5G gateway etc. 3GPP agreed simulation assumptions for XR evaluation model DL traffic arrival jitter using truncated Gaussian distribution with mean: Oms, std. dev: 2 ms, range: [−4 ms, 4 ms](baseline), [−5 ms, 5 ms](optional).

Applications can have a certain delay requirement on a PDU set, that may not be adequately translated into packet delay budget requirements. For example, if the PSDB is 10 ms, then PDB can be set to 10 ms only if all packets of the PDU set arrive at the 5G system at the same time. If the packets are spread out, then the PDU set delay budget is measured either in terms of the arrival of the first packet of the PU set or the last packet of the PDU set. In either case, a given PSDB will result in different PDB requirements on different packets of the PDU set. It is observed that specifying the PSDB to the 5G system can be beneficial.

If the scheduler, and/or the UE is aware of delay budgets for a packet/ADU, the gNB can take this knowledge into account in scheduling transmissions, e.g., by giving priority to transmissions close to their delay budget limit, and by not scheduling (e.g., UL) transmissions; the UE can also take advantage of such knowledge to determine 1) if an UL transmission (e.g., physical uplink control channel (PUCCH) in response to PDSCH, UL pose, or PUSCH) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the gNB.

The remaining delay budget 1) for a DL transmission can be indicated to the UE in a DCI (e.g., for a packet of a video frame/slice/ADU) or via a MAC-CE (e.g., for an ADU/video frame/slice) and 2) for an UL transmission can be indicated to the gNB via an UL transmission such as UCI, PUSCH transmission, etc.

XR-Awareness relies on QoS flows, PDU Sets, Data Bursts and traffic assistance information (see TS 23.501 (incorporated herein by reference)). To enable PDU Set based QoS handling, PDU Set QoS Parameters may be provided by the SMF to the gNB as part of the QoS profile of the QoS flow (at least one of them shall be provided):

PSDB: as defined in TS 23.501 (incorporated herein by reference), upper bound for the duration between the reception time of the first PDU (at the UPF for DL, at the UE for UL) and the time when all PDUs of a PDU Set have been successfully received (at the UE in DL, at the UPF in UL). A QoS Flow is associated with only one PSDB, and when available, it applies to both DL and UL and supersedes the PDB of the QoS flow. The AN PSDB is derived by subtracting the CN PDB from the PSDB.

PDU Set Error Rate (PSER): as defined in TS 23.501, upper bound for a rate of non-congestion related PDU Set losses between RAN and the UE. A QoS Flow is associated with only one PSER, and when available, it applies to both DL and UL and supersedes the PER of the QoS flow. In this release, a PDU set is considered as successfully delivered only when all PDUs of a PDU Set are delivered successfully.

PDU Set Integrated Handling Information (PSIHI): indicates whether all PDUs of the PDU Set are needed for the usage of PDU Set by application layer, as defined in TS 23.501. The PDU Set QoS parameters are common for all PDU Sets within a QoS flow.

In addition, the UPF can identify PDUs that belong to PDU Sets, and may determine the following PDU Set Information which it sends to the gNB in the GTP-U header—PDU Set Sequence Number, Indication of End PDU of the PDU Set, PDU Sequence Number within a PDU Set, PDU Set Size in bytes, PSI, which identifies the relative importance of a PDU Set compared to other PDU Sets within the same QoS Flow.

Traffic assistance information may also be provided by 5GC to the gNB via Time-Sensitive Communications Assistance Information (TSCAI) (for both guaranteed bit rate (GBR) and non-GBR QoS flows), UL and/or DL Periodicity, N6 Jitter Information (e.g., between user plane function (UPF) and Data Network) associated with the DL Periodicity, and/or via an Indication of End of Data Burst in the GTP-U header of the last PDU in downlink. In the uplink, the UE needs to be able to identify PDU Sets and Data Bursts dynamically, including PSI.

In one embodiment, the packet arrival rate is determined by the frame generation rate, e.g., 60 fps. Accordingly, the average packet arrival periodicity is given by the inverse of the frame rate, e.g., 16.6667 ms= 1/60 fps. The periodic arrival without jitter gives the arrival time at gNB for packet with index k (=1, 2, 3 . . . ) as k/F*1000 [ms], where F is the given frame generation rates (per second). Note that this periodic packet arrival implicitly assumes fixed delay contributed from network side including fixed video encoding time, fixed network transfer delay, etc.

However, in a real system, the varying frame encoding delay and network transfer time introduces jitter in packet arrival time at gNB which. In this model, the jitter is modelled as a random variable added on top of periodic arrivals. The jitter follows truncated Gaussian distribution with following statistical parameters shown below.

Statistical parameters for jitter

| | | Baseline value for | Optional value for |
|---|---|---|---|
| Parameter | unit | evaluation | evaluation |
| Mean | ms | 0 | |
| STD | ms | 2 | |
| Truncation range | ms | [−4, 4] | [−5, 5] |

Note that the given parameter values and considered frame generation rates (60 or 120 in this model) ensure that packet arrivals are in order (e.g., arrival time of a next packet is always larger than that of the previous packet).

Thus, the periodic arrival with jitter gives the arrival time for packet with index k (=1, 2, 3 . . . ) as offset+k/F*1000+J [ms], where F is the given frame generation rates (per second) and J is a random variable capturing jitter. Note that actual traffic arrival timing of traffic for each UE could be shifted by the UE specific arbitrary offset.

In one embodiment, a possible implementation for application layer forward error correction (FEC), assuming the system model for XR traffic, is implemented. Commercially available XR split rendering and cloud gaming services as introduced above follow the same or at least similar principles. In this case, the ADUs are not sent directly to the network, but they are added to a source block that then generates packets of basically equal size in order to then distribute the content.

Each ADU (for example a video frame, or an object) is assigned a size F and additional properties, for example the type of the ADU, its importance, its delay constraints and so on. The properties are typically different for each ADU. Each ADU forms a source block with K encoding symbols, each of size T. Typically, the number of K is different for each ADU in a sequence of ADUs. Each of the initial K encoding symbol forms the payload of K source packets, whereby each packet may include some of the properties, and includes the source block size K as well as the encoding symbol id (ESI). The size of the object, F, may be carried as part of the source block as shown in FIG. 1. In addition to K source packets, N-K repair packets may be sent as part of this ADU. The repair packets would be assigned to the same ADU, for example using a unique Transport Object Identifier (TOI) for ADU.

At the receiving end, assuming that the code is maximum distance separable (MDS), as the case for RaptorQ or Reed-Solomon codes, e.g., K out of the N packets are sufficient to recover the ADU, the receiver collects K symbols, determines the symbol size T based on the payload size, applies FEC decoding, recovers the source block, reads the size F from the K-th source symbols and recovers the ADU for the next layer in the protocol stack. Such a system is aligned with FEC Building Block.

The FEC Payload ID (e.g., the information carried in every packet header), carries the encoding symbol ID and the source block size K. As an example, for RaptorQ, the maximum source block size is 56403, e.g., 16 bits are sufficient. It is expected that to signal the ESI, 1 or 2 bytes would be sufficient for most applications. In addition, a TOI may be carried, again using 1 or 2 bytes. While the above FEC configuration only serves as one reference, it may be considered as typical implementation. An example sender configuration for FEC is provided below.

```
{
  “S-Trace”: {
    “source”: “S-Trace.csv”,
    “startTime”: 0
  },
  “FEC”: {
    “symbolSize”: “1468”,
    “packet-overhead”: “46”,
    “fec-overhead-percent”: “30”
  },
  “Bitrate”: “10000000”,
  “P-Trace”: “P-Trace.csv”
}
```

At the receiver, if one or more packets associated with the ADU are lost, then the timestamp of the loss is the time at which the first lost packet is detected. However, as in-order delivery cannot be assumed, a maximum delay of an ADU needs to be set, typically compared to the render time, after which only received packets are processed as part of the ADU. If at least K packets are received for an ADU within the time budget, the ADU can be fully recovered. If less than K packets are received, the ADU cannot be recovered and one of the following two error handling modes can be configured:

ADU loss: If more than N-K of the packets associated to the ADU are lost, the entire ADU is lost.

Suffix loss: If more than N-K of the packets associated to the ADU are lost, then only the correct prefix preceding the first loss of a source packet is used to generate a partially received ADU.

In one embodiment, the NW can configure the UE whether to trigger delay status reporting. When UE triggers reporting delay information for a LCG, and UE also reports the buffer status associated with the remaining time. RAN2 aims to define a single MAC CE for the DSR reporting (including the buffer status). Many companies think single value per LCG is sufficient. Some companies think scheduler needs more information. Support threshold based DSR reporting, e.g. DSR reporting is triggered when remaining delay of a PDU/PDU set is below a NW configured threshold. The threshold is configured per LCG.

Delay-critical RLC SDU may be an RLC SDU corresponding to a PDCP PDU indicated as delay-critical by PDCP. For the purpose of MAC buffer status reporting, the UE shall consider the following to be an RLC data volume—RLC SDUs and RLC SDU segments that have not yet been included in an RLC data PDU, RLC data PDUs that are pending for initial transmission, and RLC data PDUs that are pending for retransmission (RLC AM).

For the purpose of MAC delay status reporting, the UE shall consider the following as delay-critical RLC data volume—delay-critical RLC SDUs and delay-critical RLC SDU segments that have not yet been included in an RLC data PDU, RLC data PDUs pending for initial transmission, and containing a delay-critical RLC SDU or a delay-critical RLC SDU segment, and RLC data PDUs that are pending for retransmission (RLC AM).

In addition, if a STATUS PDU has been triggered and t-StatusProhibit is not running or has expired, the UE shall estimate the size of the STATUS PDU that will be transmitted in the next transmission opportunity, and consider this as part of RLC data volume for MAC buffer status reporting and as part of delay-critical RLC data volume for MAC delay status reporting.

Delay-critical PDCP SDU may be, ifpdu-SetDiscard is not configured, a PDCP SDU for which the remaining time till discardTimer expiry is less than the remainingTimeThreshold. If pdu-SetDiscard is configured, a PDCP SDU belonging to a PDU Set of which at least one PDCP SDU has the remaining time till discardTimer expiry less than the remainingTime Threshold.

For the purpose of MAC delay status reporting, the transmitting PDCP entity shall consider the following as delay-critical PDCP data volume—the delay-critical PDCP SDUs for which no PDCP Data PDUs have been constructed, the PDCP Data PDUs that contain the delay-critical PDCP SDUs and have not been submitted to lower layers, the PDCP Control PDUs, for AM DRBs, the PDCP SDUs to be retransmitted, for AM DRBs, the PDCP Data PDUs to be retransmitted. If a PDCP SDU becomes a delay-critical PDCP SDU, and if the corresponding PDCP Data PDU has already been submitted to lower layers, the delay-critical indication for the PDCP Data PDU is provided to lower layers.

According to one embodiment, the UE compares a data volume against a preconfigured threshold to determine whether a PDCP data volume is indicated to multiple MAC entities for the purpose of DSR reporting. According to one implementation of the embodiment, the UE/PDCP layer compares the total amount of PDCP data volume and RLC data volume pending for initial transmission in the primary RLC entity and the at least one secondary RLC entity of a split bearer, e.g., split secondary RLC entity, against a predefined threshold, e.g., ul-DataSplitThreshold. For cases when the PDCP entity is associated with multiple RLC entities, e.g. split bearer, if the data volume, e.g., the total amount of PDCP data volume and RLC data volume pending for initial transmission (e.g., as specified in TS 38.322) in the primary RLC entity and the split secondary RLC entity, is equal to or larger than the threshold (ul-DataSplitThreshold), the PDCP entity indicates the delay-critical PDCP data volume to both the MAC entity associated with the primary RLC entity and the MAC entity associated with the split secondary RLC entity for the purpose of DSR reporting, e.g. Buffer status field within the DSR MAC CE. In one example, the PDCP entity indicates the delay-critical PDCP data volume (delay-critical PDCP SDU data volume) as 0 to the MAC entity associated with RLC entity other than the primary RLC entity and the split secondary RLC entity for the purpose of DSR reporting.

In case the data volume is smaller or less than the threshold, the PDCP entity indicates, according to one implementation of the embodiment, the delay-critical PDCP data volume (e.g., delay-critical PDCP SDU as defined in TS38.323) to the MAC entity associated with the primary RLC entity or primary path and indicates the delay-critical PDCP data volume as zero to the MAC entity associated with the RLC entity other than the primary RLC entity or primary path, e.g., split secondary RLC entity.

According to the current specified UE behavior, e.g., described in TS38.323, a PDCP entity that is associated with multiple RLC entities, e.g., split bearer, performs a data volume comparison against a configured threshold to determine whether a PDCP PDU is submitted to only the primary RLC entity/path or also to the secondary RLC entity(es). For cases where the data volume is larger than or equal to the threshold, e.g., for a large amount of data pending for transmission, more than one link should be used for UL transmission. For cases when the amount of data, e.g., total amount of PDCP data volume and RLC data volume pending for initial transmission (e.g., as specified in TS 38.322) in the primary RLC entity and the split secondary RLC entity, is smaller than the threshold (small amount of data pending for transmission) UE should only use the primary link for UL transmissions. Since the amount of delay-critical PDCP SDUs/PDUs—which is reported in a DSR MAC CE—is most likely smaller than the data volume which is compared against the threshold since the data volume is comprised of the total amount of PDCP volume as well as the RLC data volume pending for initial transmission, the data volume which is used for determining the delay critical PDCP data volume calculation for the purpose of DSR reporting should be the same data volume which is used for determining whether a PDCP PDU is submitted to only the primary link or also the secondary links/paths.

Otherwise, there would be some mismatch between the calculation of the delay critical PDCP data volume for DSR reporting and the PDCP transmission behaviour for the split bearer case. Similar to the BSR reporting, also for DSR reporting, the UE behaviour should be aligned with the PDCP transmission behaviour, e.g. when DSR is reporting the delay-critical PDCP PDU data volume to primary as well as secondary RLC/paths then also PDCP layer should be allowed to submit a delay-critical PDCP PDU to either primary RLC entity or secondary RLC entity. We should avoid situations, where DSR reports the delay-critical PDCP data volume only to the primary path/RLC even though the UE/PDCP layer uses multiple paths/links for UL data transmission, e.g. delay-critical PDCP PDUs.

In one embodiment, if the transmitting PDCP entity is associated with at least two RLC entities, or with an RLC entity and either an Sidelink Relay Adaptation Protocol (SRAP) entity or the N3C, when indicating the PDCP data volume to a MAC entity for BSR triggering and Buffer Size calculation (e.g., as specified in TS 38.321 and TS 36.321), the transmitting PDCP entity shall, if the PDCP duplication is activated for the RB, indicate the PDCP data volume to the MAC entity associated with the primary RLC entity or primary path, indicate the PDCP data volume excluding the PDCP Control PDU to the MAC entity associated with the RLC entity other than the primary RLC entity or primary path activated for PDCP duplication, and indicate the PDCP data volume as 0 to the MAC entity associated with RLC entity deactivated for PDCP duplication.

Otherwise, if PDCP duplication is deactivated for the RB or the RB is a Dual Active Protocol Stack (DAPS) bearer, the transmitting PDCP entity shall indicate the PDCP data volume to both the MAC entity associated with the primary RLC entity and the MAC entity associated with the split secondary RLC entity and indicate the PDCP data volume as 0 to the MAC entity associated with RLC entity other than the primary RLC entity and the split secondary RLC entity, if the split secondary RLC entity is configured and if the total amount of PDCP data volume and RLC data volume pending for initial transmission (e.g., as specified in TS 38.322) in the primary RLC entity and the split secondary RLC entity is equal to or larger than ul-DataSplitThreshold.

According to one embodiment, a PDCP entity of a split bearer compares the total amount of delay-critical PDCP data volume against a threshold to determine whether the delay-critical PDCP data volume, e.g., delay-critical PDCP SDU(s), is indicated to only the primary MAC entity/path (MAC entity associated with the primary RLC entity) or also to MAC entities/paths other than the primary, e.g. MAC entity associated with the split secondary RLC entity. In one example, the total amount of delay-critical PDCP data volume and at least part of the delay-critical RLC data volume, e.g. delay-critical RLC data volume pending for initial transmission, in the primary RLC entity and the (split) secondary RLC entity is compared against the threshold.

In one example, the threshold is the ul-DataSplitThreshold configured by the NW. In another example the PDCP entity compares the total amount of delay-critical PDCP data volume and delay-critical RLC data volume pending for initial transmission including the delay-critical RLC SDUs and delay-critical RLC SDU segments that have not yet been included in an RLC data PDU in the primary RLC entity and the (split) secondary RLC entity against the threshold in order to determine whether delay-critical PDCP data volume is indicated to only the primary MAC entity/path (MAC entity associated with the primary RLC entity) or also to MAC entities/paths other than the primary, e.g., MAC entity associated with the split secondary RLC entity, for the purpose of delay status reporting (DSR MAC CE).

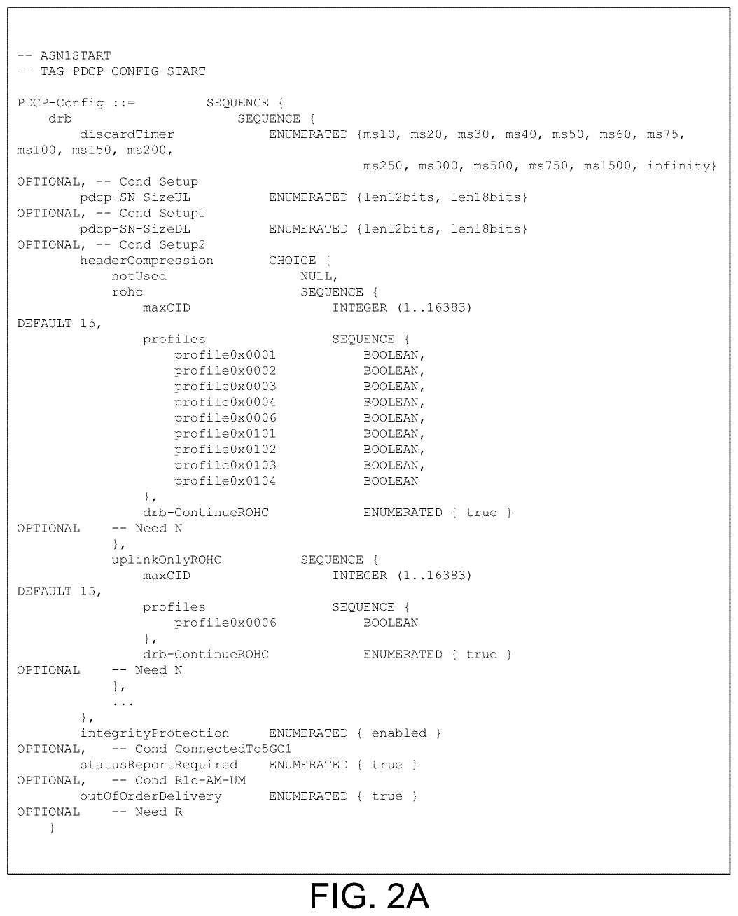

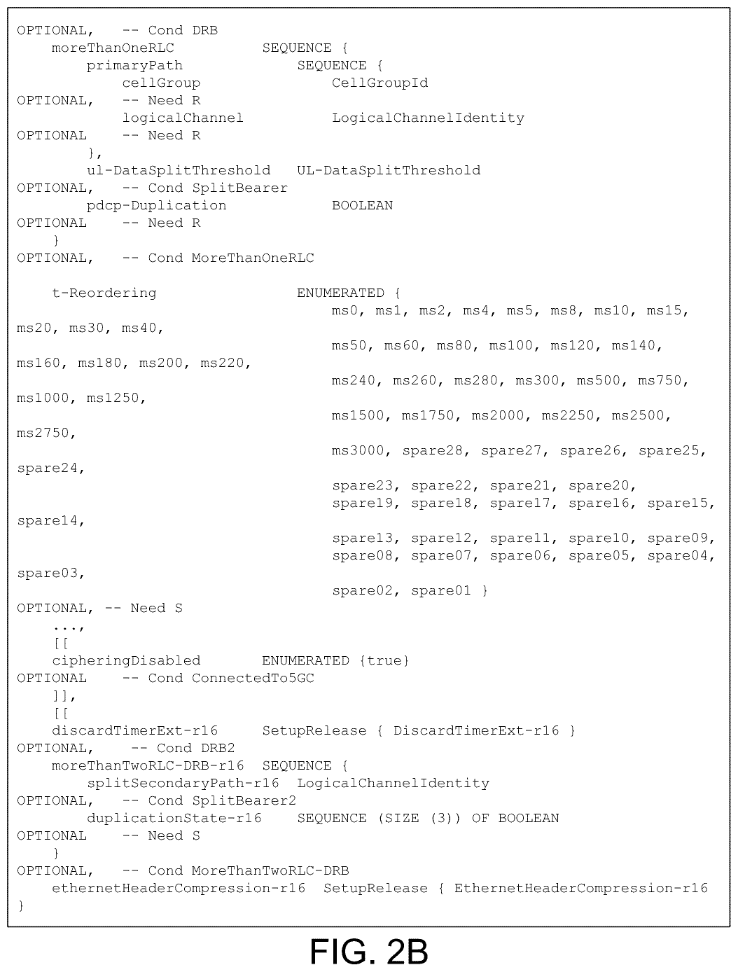

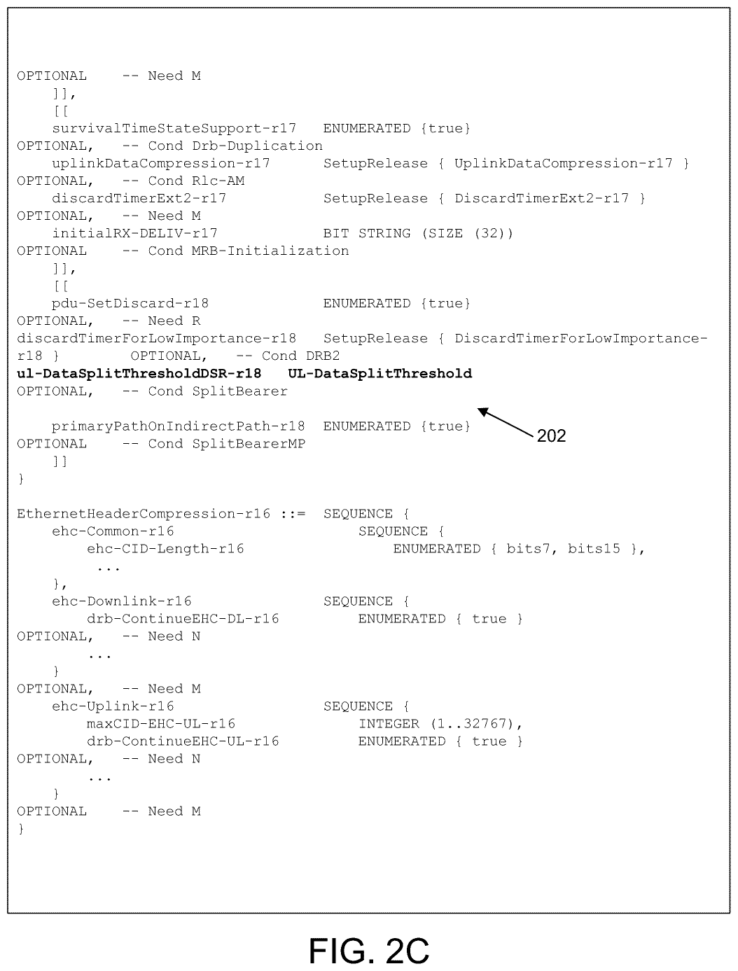

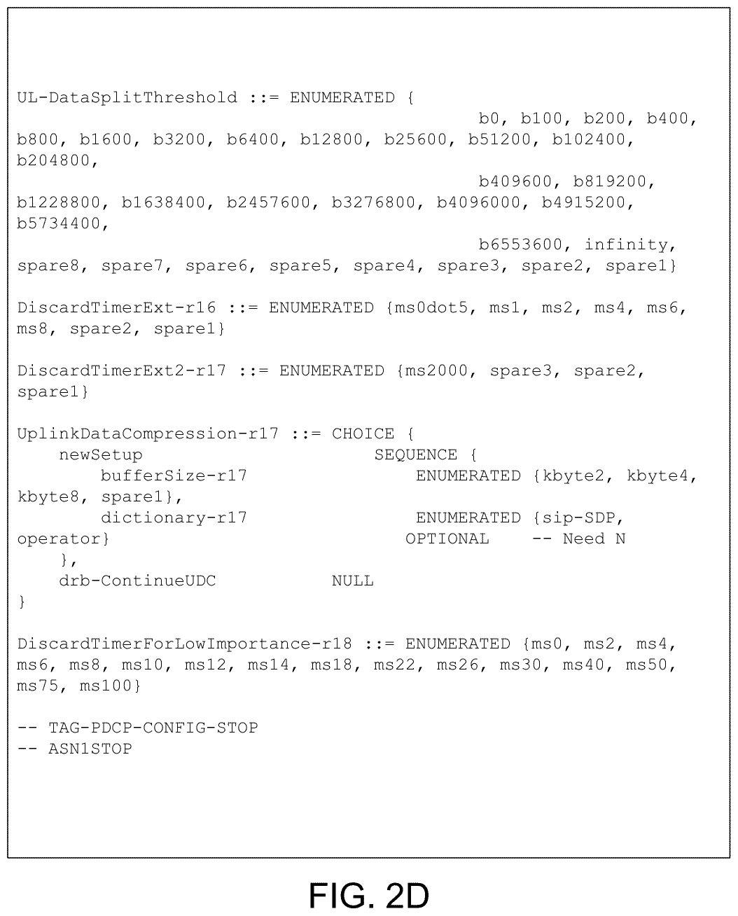

According to one embodiment, a new threshold is configured by the NW for the data volume calculation for the purpose of DSR reporting. Since the data volume of the delay-critical PDCP SDUs (delay-critical PDCP data volume) is smaller than the total PDCP data volume and the and RLC data volume pending for initial transmission in the primary RLC entity and the at least one secondary RLC entity a different threshold for the comparison is introduced. In addition to the IE/field ul-DataSplitThreshold, a new field/IE is signalled within the IE PDCP-Config, as shown in FIGS. 2A-2D. In one example the new field is referred to as ul-DataSplitThresholdDSR-r18 202 and is applied by the PDCP entity of a split bearer for the purpose of delay status reporting. The IE PDCP-Config is used to set the configurable PDCP parameters for signalling, MBS multicast and data radio bearers.

According to one embodiment, the DSR triggering from PDCP entity to MAC entity is done based on a data volume comparison. According to one implementation of the embodiment, the PDCP layer of a split bearer triggers a DSR to either one MAC entity, e.g. MAC entity associated with the primary RLC entity, or multiple MAC entities, based on the result of the data volume comparison. In one example, PDCP/UE layer triggers only a DSR for the MAC entity associated with the primary RLC entity if the delay-critical PDCP data volume (and optionally at least part of the delay-critical RLC data volume, e.g. pending for initial transmission, in the primary and secondary RLC entity) is smaller than a configured threshold. If the delay-critical PDCP data volume (and optionally at least part of the delay-critical RLC data volume, e.g. pending for initial transmission, in the primary and secondary RLC entity) is equal to or larger than a configured threshold, PDCP entity triggers a DSR for the MAC entity associated with the primary RLC entity and the MAC entity associated with the (split) secondary RLC entity.

According to one embodiment, a PDCP entity of a split bearer indicates for the purpose of DSR reporting the delay-critical PDCP data volume always to the MAC entity associated to the primary RLC entity and the MAC entity associated with the (split) secondary RLC entity. According to one implementation of the embodiment, no data volume comparison against a threshold is performed. In order to ensure a timely delivery of the delay-critical data, the delay-critical PDCP data volume is indicated also to other MAC entities tan the MAC entity associate with the primary RLC entity.

According to one embodiment, a PDCP entity of a split bearer doesn't trigger a DSR for a MAC entity other than the MAC entity associated with the primary RLC entity if the delay-critical RLC data volume of the secondary RLC entity is below a configured threshold. In one example PDCP of a split bearer triggers only a DSR to the MAC entity associated with the primary RLC entity. In one example, the PDCP entity of a split bearer triggers only a DSR to the MAC entity of associated with the primary RLC entity if the delay-critical RLC data volume is below a configured threshold, e.g. if the total amount of delay-critical RLC data volume is zero (bytes).

According to one embodiment, the MAC entity cancels a DSR if the buffer status indicated within the DSR MAC CE is zero bytes. According to one implementation of the embodiment, a DSR with a non-empty, e.g. a nonzero, BS field is reported.

According to one embodiment, a PDCP entity of a split bearer submits a delay-critical PDCP PDU to either the primary RLC entity/path or a (split) secondary RLC entity/path. It should be ensured that delay-critical PDCP PDUs can be transmitted via any of the RLC entities to ensure a timely delivery.

According to one embodiment, NW configures the UE/PDCP layer with a configuration indicating whether the PDCP layer/UE should indicate the delay-critical PDCP data volume to only the MAC entity associated with the primary RLC entity or also to the MAC entity associated with the split secondary RLC entity. According to one implementation of the embodiment, the new configuration is signaled per radio bearer, e.g., in the IE PDCP-Config. In one example the NW configures for a PDCP entity the RLC entity/path or the MAC entity associated with the RLC entity to which the delay-critical PDCP data volume is indicated for the purpose of delay status reporting.

According to one embodiment, the NW configures a PDCP layer with a configuration indicating whether the data volume used for a threshold comparison in the delay critical data volume calculation procedure is the total amount of delay-critical PDCP data volume and optionally at least part of the delay-critical RLC data volume, e.g., delay-critical RLC data volume pending for initial transmission, in the primary RLC entity and the (split) secondary RLC entity, or the total amount PDCP data volume and RLC data volume pending for initial transmission in the primary RLC entity and the (split) secondary RLC entity.

According to one embodiment, the UE/MAC entity should trigger a SR for a DSR, e.g. DSR MAC CE, even if a logicalChannelSR-DelayTimer is running. logicalChannelSR-DelayTimer is very useful for power saving and efficiency improvement of resource usage by preventing frequent SR triggering. However, since the transmission of a DSR MAC CE is time critical, the UE should not delay the triggering/transmission of a SR if the SR is triggered by a DSR procedure.

According to one embodiment, a MAC entity of the UE should trigger a SR for DSR, e.g., DSR MAC CE, even if the MAC entity of the UE is configured with configured UL grant(s) and the DSR was triggered for a LCH for which logicalChannelSR-Mask is set to true. Since the DSR information is time critical and further since the logicalChannelSR-Mask is configured for BSR reporting, which might not be so time critical, the configuration should not apply for DSR reporting.

In certain embodiments, the data volume used in a comparison against a threshold to determine whether a delay-critical PDCP data volume is indicated to a primary MAC entity or also to a secondary MAC entity is the same data volume as used for BSR reporting and PDCP transmission behaviour. In one embodiment, data volume used for DSR reporting is the total sum of total amount of PDCP data volume and RLC data volume pending for initial transmission (e.g., as specified in TS 38.322) in the primary RLC entity and the split secondary RLC entity.

In one embodiment, the data volume used in a comparison against a threshold to determine whether a delay-critical PDCP data volume is indicated to a primary MAC entity or also to a secondary MAC entity is the delay-critical PDCP data volume and potentially delay-critical RLC data volume pending for initial transmission in the primary and secondary RLC entity.

In one embodiment, PDCP indicates the delay-critical PDCP data volume to both MAC entities. In one embodiment, a new threshold is configured for the data volume comparing for the purpose of DSR reporting. In one embodiment, new RLC data volume threshold is introduced where a PDCP entity of a split bearer doesn't trigger a DSR for a MAC entity other than the MAC entity associated with the primary RLC entity if the delay-critical RLC data volume of the secondary RLC entity is below a configured threshold.

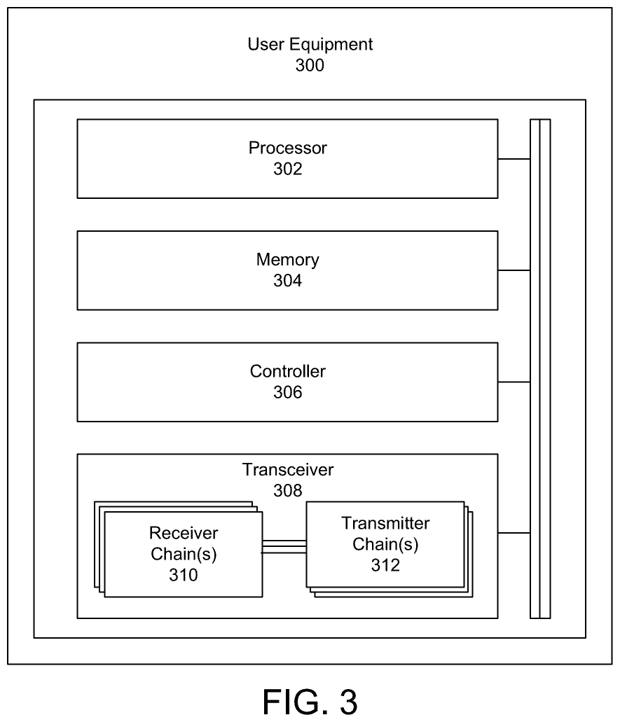

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the UE functions described herein (e.g., executing, by the processor 302, instructions stored in the memory 304). Accordingly, the processor 302 may support wireless communication at the UE 300 in accordance with examples as disclosed herein.

In one embodiment, the UE 300 may be configured to associate a PDCP entity with a primary RLC entity and at least one secondary RLC entity, indicate a data volume associated with the PDCP entity to a MAC entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

In one embodiment, the amount of data available for transmission comprises a total amount of the data volume associated with the PDCP entity and the RLC data volume pending for initial transmission in the primary RLC entity and the at least one secondary RLC entity.

In one embodiment, the amount of the data volume associated with the PDCP entity comprises a delay-critical PDCP data volume. In one embodiment, the UE 300 is configured to indicate the delay-critical PDCP data volume to the MAC entity associated with the primary RLC entity and to a MAC entity associated with the at least one secondary RLC entity for DSR in response to the amount of data available for transmission being greater than or equal to the threshold.

In one embodiment, the UE 300 is configured to indicate to the MAC entity associated with the at least one secondary RLC entity that the amount of the data volume associated with the PDCP entity for DSR is zero in response to the amount of data available for transmission being less than the threshold.

In one embodiment, the primary RLC entity and the at least one secondary RLC entity belong to two different cell groups. In one embodiment, the at least one secondary RLC entity is a split secondary RLC entity. In one embodiment, the threshold comprises a threshold value for uplink data split operation, ul-DataSplitThreshold.

In one embodiment, the UE 300 is configured to determine the amount of data available for transmission in response to PDCP duplication being deactivated. In one embodiment, the UE 300 is configured to report a DSR.

The controller 306 may manage input and output signals for the UE 300. The controller 306 may also manage peripherals not integrated into the UE 300. In some implementations, the controller 306 may utilize an operating system (OS) such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding/processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

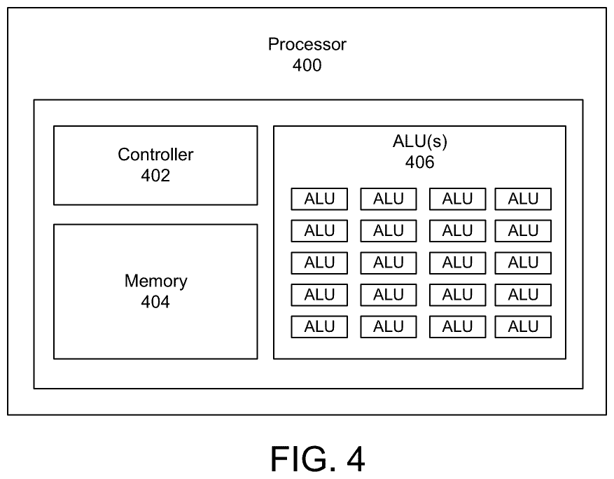

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

In various embodiments, the processor 400 may support wireless communication of a UE, in accordance with examples as disclosed herein. In other embodiments, the processor 400 may support wireless communication of a RAN entity, in accordance with examples as disclosed herein.

In one embodiment, the processor 400 may be configured to associate a PDCP entity with a primary RLC entity and at least one secondary RLC entity, indicate a data volume associated with the PDCP entity to a MAC entity for DSR, determine an amount of data available for transmission based on the data volume associated with the PDCP entity and an RLC data volume that is pending for initial transmission in the primary RLC entity and the at least one secondary RLC entity, and indicate an amount of the data volume associated with the PDCP entity to the MAC entity associated with the primary RLC entity for DSR in response to the amount of data available for transmission being less than a threshold.

In one embodiment, the amount of data available for transmission comprises a total amount of the data volume associated with the PDCP entity and the RLC data volume pending for initial transmission in the primary RLC entity and the at least one secondary RLC entity.

In one embodiment, the amount of the data volume associated with the PDCP entity comprises a delay-critical PDCP data volume. In one embodiment, the processor 400 is configured to indicate the delay-critical PDCP data volume to the MAC entity associated with the primary RLC entity and to a MAC entity associated with the at least one secondary RLC entity for DSR in response to the amount of data available for transmission being greater than or equal to the threshold.

In one embodiment, the processor 400 is configured to indicate to the MAC entity associated with the at least one secondary RLC entity that the amount of the data volume associated with the PDCP entity for DSR is zero in response to the amount of data available for transmission being less than the threshold.

In one embodiment, the primary RLC entity and the at least one secondary RLC entity belong to two different cell groups. In one embodiment, the at least one secondary RLC entity is a split secondary RLC entity. In one embodiment, the threshold comprises a threshold value for uplink data split operation, ul-DataSplitThreshold.

In one embodiment, the processor 400 is configured to determine the amount of data available for transmission in response to PDCP duplication being deactivated. In one embodiment, the processor 400 is configured to report a DSR.

In one embodiment, the processor 400 may be configured to determine a threshold associated with an amount of data available for transmission for DSR for a split bearer, transmit the determined threshold to a UE for DSR, and receive communications from the UE in accordance with the determined threshold.

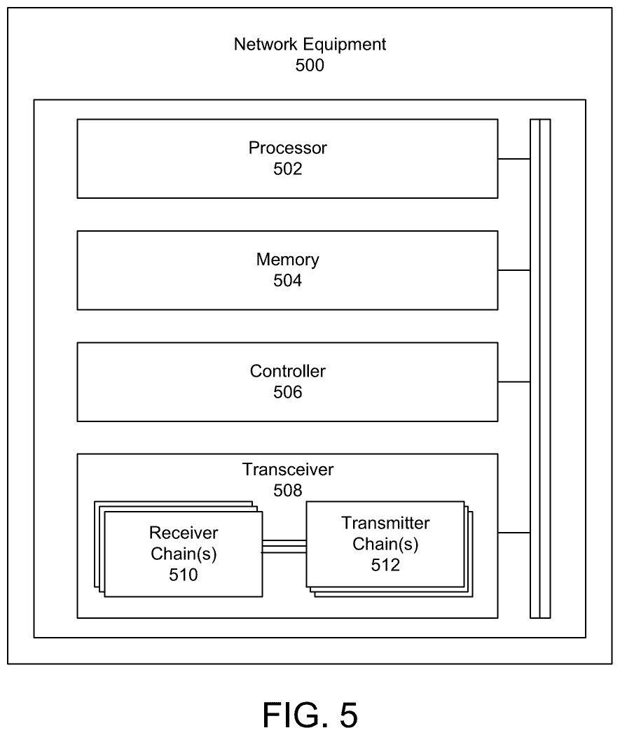

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the RAN functions described herein (e.g., executing, by the processor 502, instructions stored in the memory 504). For example, the processor 502 may support wireless communication at the NE 500 in accordance with examples as disclosed herein.

In one embodiment, the NE 500 may be configured to determine a threshold associated with an amount of data available for transmission for DSR for a split bearer, transmit the determined threshold to a UE for DSR, and receive communications from the UE in accordance with the determined threshold.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

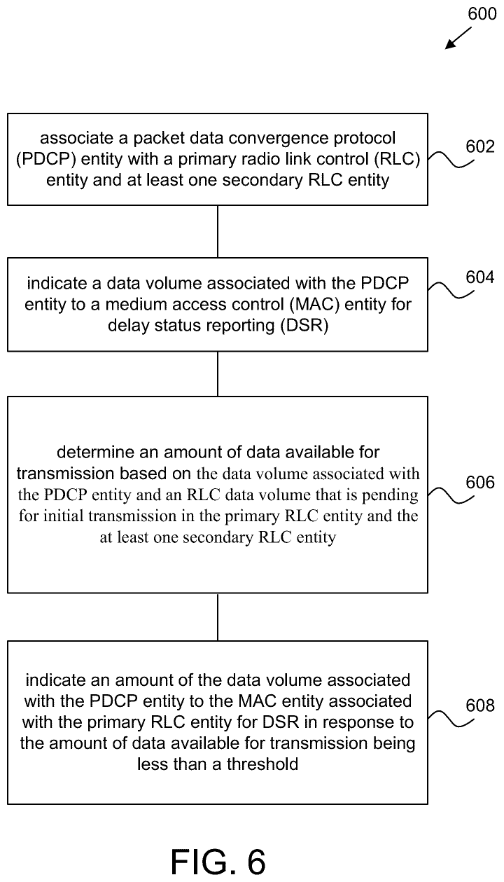

FIG. 6 illustrates a flowchart of a method 600 performed by an UE in accordance with aspects of the present disclosure. The operations of the method 600 may be implemented by a UE as described herein. In some implementations, the UE may execute a set of instructions to control the function elements of the UE to perform the described functions.

At step 602, the method 600 may associate a PDCP entity with a primary RLC entity and at least one secondary RLC entity. The operations of step 602 may be performed in accordance with examples as described herein. In some implementations, aspects of the operations of step 602 may be performed by a UE 300, as described with reference to FIG. 3.

At step 604, the method 600 may indicate a data volume associated with the PDCP entity to a MAC entity for DSR. The operations of step 604 may be performed in accordance with examples as described herein. In some implementations, aspects of the operations of step 604 may be performed by a UE 300, as described with reference to FIG. 3.

At step 606, the method 600 may determine an amount of data available for transmission based on the data volume associated with the PDCP entity and an RLC data volume that is pending for initial transmission in the primary RLC entity and the at least one secondary RLC entity. The operations of step 606 may be performed in accordance with examples as described herein. In some implementations, aspects of the operations of step 606 may be performed by a UE 300, as described with reference to FIG. 3.

At step 608, the method 600 may indicate an amount of the data volume associated with the PDCP entity to the MAC entity associated with the primary RLC entity for DSR in response to the amount of data available for transmission being less than a threshold. The operations of step 608 may be performed in accordance with examples as described herein. In some implementations, aspects of the operations of step 608 may be performed by a UE 300, as described with reference to FIG. 3.

It should be noted that the method 600 described herein describes one possible implementation, and that the operations and the steps may be rearranged or otherwise modified and that other implementations are possible.

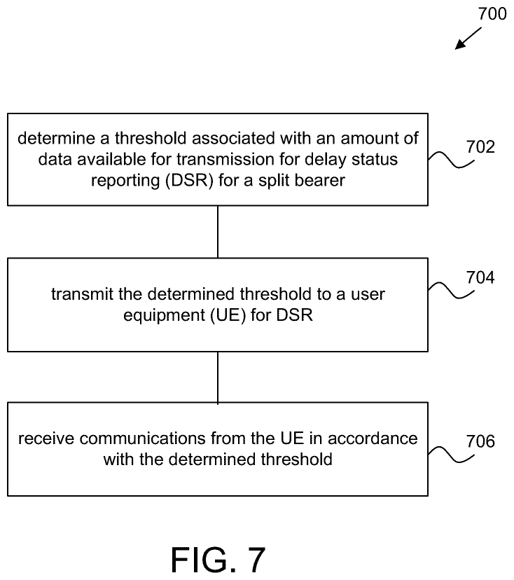

FIG. 7 illustrates a flowchart of a method 700 performed by an NE in accordance with aspects of the present disclosure. The operations of the method 700 may be implemented by an NE 500 as described herein. In some implementations, the NE 500 may execute a set of instructions to control the function elements of the NE 500 to perform the described functions.

At step 702, the method 700 may determine a threshold associated with an amount of data available for transmission for DSR for a split bearer. The operations of step 702 may be performed in accordance with examples as described herein. In some implementations, aspects of the operations of step 702 may be performed by a NE 500, as described with reference to FIG. 5.

At step 704, the method 700 may transmit the determined threshold to a UE for DSR. The operations of step 704 may be performed in accordance with examples as described herein. In some implementations, aspects of the operations of step 704 may be performed by a NE 500, as described with reference to FIG. 5.

At step 706, the method 700 may receive communications from the UE in accordance with the determined threshold. The operations of step 706 may be performed in accordance with examples as described herein. In some implementations, aspects of the operations of step 706 may be performed by a NE 500, as described with reference to FIG. 5.

It should be noted that the method 600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
associate a packet data convergence protocol (PDCP) entity with a primary radio link control (RLC) entity and at least one secondary RLC entity;
indicate a data volume associated with the PDCP entity to a medium access control (MAC) entity for delay status reporting (DSR);
determine an amount of data available for transmission based on:
the data volume associated with the PDCP entity; and
an RLC data volume that is pending for initial transmission in the primary RLC entity and the at least one secondary RLC entity; and
indicate an amount of the data volume associated with the PDCP entity to the MAC entity associated with the primary RLC entity for DSR in response to the amount of data available for transmission being less than a threshold.

2. The UE of claim 1, wherein the amount of data available for transmission comprises a total amount of the data volume associated with the PDCP entity and the RLC data volume pending for initial transmission in the primary RLC entity and the at least one secondary RLC entity.

3. The UE of claim 1, wherein the amount of the data volume associated with the PDCP entity comprises a delay-critical PDCP data volume.

4. The UE of claim 3, wherein the at least one processor is configured to cause the UE to indicate the delay-critical PDCP data volume to the MAC entity associated with the primary RLC entity and to a MAC entity associated with the at least one secondary RLC entity for DSR in response to the amount of data available for transmission being greater than or equal to the threshold.

5. The UE of claim 1, wherein the at least one processor is configured to cause the UE to indicate to the MAC entity associated with the at least one secondary RLC entity that the amount of the data volume associated with the PDCP entity for DSR is zero in response to the amount of data available for transmission being less than the threshold.

6. The UE of claim 1, wherein the primary RLC entity and the at least one secondary RLC entity belong to two different cell groups.

7. The UE of claim 1, wherein the at least one secondary RLC entity is a split secondary RLC entity.

8. The UE of claim 1, wherein the threshold comprises a threshold value for uplink data split operation, ul-DataSplitThreshold.

9. The UE of claim 1, wherein the at least one processor is configured to cause the UE to determine the amount of data available for transmission in response to PDCP duplication being deactivated.

10. The UE of claim 1, wherein the at least one processor is configured to cause the UE to report a DSR.

11. A processor for wireless communication, comprising:
at least one controller coupled with at least one memory and configured to cause the processor to:
associate a packet data convergence protocol (PDCP) entity with a primary radio link control (RLC) entity and at least one secondary RLC entity;
indicate a data volume associated with the PDCP entity to a medium access control (MAC) entity for delay status reporting (DSR);
determine an amount of data available for transmission based on:
the data volume associated with the PDCP entity; and
an RLC data volume that is pending for initial transmission in the primary RLC entity and the at least one secondary RLC entity; and
indicate an amount of the data volume associated with the PDCP entity to the MAC entity associated with the primary RLC entity for DSR in response to the amount of data available for transmission being less than a threshold.

12. The processor of claim 11, wherein the amount of data available for transmission comprises a total amount of the data volume associated with the PDCP entity and the RLC data volume pending for initial transmission in the primary RLC entity and the at least one secondary RLC entity.

13. The processor of claim 11, wherein the amount of the data volume associated with the PDCP entity comprises a delay-critical PDCP data volume.

14. The processor of claim 13, wherein the at least one controller is configured to cause the processor to indicate the delay-critical PDCP data volume to the MAC entity associated with the primary RLC entity and to a MAC entity associated with the at least one secondary RLC entity for DSR in response to the amount of data available for transmission being greater than or equal to the threshold.

15. The processor of claim 11, wherein the at least one controller is configured to cause the processor to indicate to the MAC entity associated with the at least one secondary RLC entity that the amount of the data volume associated with the PDCP entity for DSR is zero in response to the amount of data available for transmission being less than the threshold.

16. The processor of claim 11, wherein the primary RLC entity and the at least one secondary RLC entity belong to two different cell groups.

17. The processor of claim 11, wherein the at least one secondary RLC entity is a split secondary RLC entity.

18. The processor of claim 11, wherein the threshold comprises a threshold value for uplink data split operation, ul-DataSplitThreshold.

19. A method performed by a user equipment (UE), the method comprising:
associating a packet data convergence protocol (PDCP) entity with a primary radio link control (RLC) entity and at least one secondary RLC entity;
indicating a data volume associated with the PDCP entity to a medium access control (MAC) entity for delay status reporting (DSR);
determining an amount of data available for transmission based on:
the data volume associated with the PDCP entity; and
an RLC data volume that is pending for initial transmission in the primary RLC entity and the at least one secondary RLC entity; and
indicating an amount of the data volume associated with the PDCP entity to the MAC entity associated with the primary RLC entity for DSR in response to the amount of data available for transmission being less than a threshold.

20. A base station, comprising:
at least one memory; and
at least one processor coupled with the at least one memory and configured to cause the base station to:
determine a threshold associated with an amount of data available for transmission for delay status reporting (DSR) for a split bearer;
transmit the determined threshold to a user equipment (UE) for DSR; and
receive communications from the UE in accordance with the determined threshold.
